(19) United States
(12) Patent Application Publication
(10) Pub. No.: US 2017/0227831 A1
(43) Pub. Date: Aug. 10, 2017

(54) MOTOR AND GIMBAL HAVING THE SAME

(71) Applicant: ZEROTECH (Chongqing) Intelligence Technology Co., Ltd., Chongquing (CN)

(72) Inventors: JIE TANG, Beijing (CN); GENGPENG LIU, Beijing (CN); HONGTAO SUN, Beijing (CN)

(21) Appl. No.: 15/409,651

(22) Filed: Jan. 19, 2017

(30) Foreign Application Priority Data
Feb. 4, 2016 (CN) 201610079564.8

(51) Int. Cl. G03B 15/00; H02K 5/22; G03B 17/56; B64D 47/08; B64C 39/02; F16M 11/12; H02K 11/33; H02K 11/215

(52) U.S. Cl. CPC G03B 15/006; H02K 11/33; H02K 5/225; H02K 11/215; B64D 47/08; B64C 39/024; F16M 11/123; G03B 17/561; B64C 2201/127

(57) ABSTRACT

A motor and a gimbal having the same. The motor includes a stator and a rotor, and further includes a connection shaft. The rotor is fixedly connected with the connection shaft, the connection shaft is rotatably connected with the stator through a bearing, and the connection shaft is provided in an axial direction thereof with a central through hole. The present disclosure further discloses a gimbal using the motor described above. In an embodiment, it is able to avoid the problem that a signal wire is wound and exposed outside the motor or the gimbal, solve the problem that the signal wire could be released or rewound with the positive or negative rotation of the motor, and reduce the length of the wire.

### CROSS-REFERENCE TO RELATED APPLICATION

The present application claims priority to and the benefit of the filing date of Chinese Patent Application No. 201610079564.8, filed on Feb. 4, 2016 with the State Intellectual Property Office of China and entitled “Motor and Gimbal,” the content of which is hereby incorporated by reference in its entirety.

### FIELD

Embodiments of the present disclosure relate to the technical field of unmanned aerial vehicles, and more particularly, to a motor and a gimbal having the same.

### BACKGROUND

With the development of the unmanned aerial vehicle technology, the technology of aerial photographing with the unmanned aerial vehicle comes out, where it is necessary to use a gimbal during the aerial photographing.

In general, the gimbal is a supporting platform for mounting a photographing apparatus, and photographing of an object from various angles may be achieved by adjusting the gimbal. However, as for a prior gimbal, devices, such as a motor and a camera, are generally connected with a controller by winding flexible wires outside the gimbal. However, under this wiring mode, there is a disadvantage that it is necessary to set a segment of a wire aside during winding the wire around an output shaft of the motor, such that the wire wound around the output shaft of the motor could be released or rewound with the positive or negative rotation of the motor, when the motor rotates. Therefore, the wire is scattered outside the gimbal; moreover, since there is a need to set a segment of the wire aside for cooperating with the rotation of the motor, the length of the flexible wire is increased as a whole, which affects the effect of a transmitted image.

### SUMMARY

In view of this, it is necessary to provide a motor and a gimbal having the same, so as to achieve reduction in the length of the signal wire and avoid the problem that the signal wire is wound and exposed outside the structure.

An embodiment of the present disclosure provides a motor. The motor includes a stator and a rotor, and further includes a connection shaft. The rotor is fixedly connected with the connection shaft, the connection shaft is rotatably connected with the stator through a bearing, and the connection shaft is provided in an axial direction thereof with a central through hole.

Preferably, the motor further includes a drive board, with the drive board electrically connected with the stator of the motor and driving the motor.

Preferably, the motor further includes a magnetic encoder, with the magnetic encoder electrically connected with the drive board and configured to measure angle and/or position information of the motor and feed back the measured information to the drive board.

An embodiment of the present disclosure further provides a gimbal based on the motor as described above, which includes a fixing base, a photographing apparatus, a signal wire and at least one motor as described above. The fixing base is connected with the photographing apparatus through the at least one motor. The signal wire is arranged to pass through the central through hole of the connection shaft of the at least one motor.

Preferably, the motors included in the gimbal are in number of two or three, with the two or three motors connected in series, and the gimbal further includes a connecting arm connected between two adjacent ones of the motors. A guide channel is provided inside the connecting arm, and the signal wire is arranged to pass through the guide channel and the central through holes of the connection shafts of the motors. In the motors connected in series, first one is fixedly connected with the fixing base, and last one is fixedly connected with the photographing apparatus.

Preferably, the axial directions of the connection shafts of the two or three motors are perpendicular to one another.

Preferably, the gimbal further includes a main control board, with the main control board fixed onto any of the motors of the gimbal and configured to adjust rotation of the at least one motor based on attitude information of the photographing apparatus.

Preferably, the main control board is electrically connected with the stator of the at least one motor through the signal wire; or the at least one motor each includes a drive board, and the main control board is electrically connected with the drive board of the motor through the signal wire.

Preferably, the at least one motor in the gimbal uses one drive board, with the drive board fixedly connected onto any of the motors of the gimbal.

Preferably, the gimbal further includes an inertial measurement unit and a main control board, the inertial measurement unit is electrically connected with the main control board and fixed onto the motor connected with the photographing apparatus, and the inertial measurement unit is configured to sense attitude information of the photographing apparatus and send the attitude information of the photographing apparatus to the main control board.

An embodiment of the present disclosure further provides a gimbal, which includes at least one motor including a stator, a rotor and a connection shaft. The rotor is fixedly connected with the connection shaft, the connection shaft is rotatably connected with the stator through a bearing, and the connection shaft is provided in an axial direction thereof with a central through hole.

The present disclosure has the following beneficial effects: with the motor and the gimbal based on the motor provided by the embodiments of the present disclosure, it is able to avoid the problem in the prior art that the signal wire is wound and exposed outside the motor or the gimbal, solve the problem that the signal wire could be released or rewound with the positive or negative rotation of the motor, and reduce the length of the wire.

### BRIEF DESCRIPTION OF THE DRAWINGS

FIG. 1 is a schematic structural view of a motor provided by an embodiment of the present disclosure;

FIG. 2 is a schematic assembly diagram of a gimbal using the motor shown in FIG. 1;

FIG. 3 is a schematic assembly diagram of another gimbal using the motor shown in FIG. 1; and

FIG. 4 is a view of a control system of the gimbal shown in FIG. 3.

### DETAILED DESCRIPTION

The present disclosure will be further described below in detail in conjunction with the drawings and embodiments. It is to be understood that specific embodiments described herein are intended only to explain the present disclosure, rather than limiting the present disclosure. It is also to be noted that only parts, but not all, of the structures associated with the present disclosure are shown in the drawings for the sake of description.

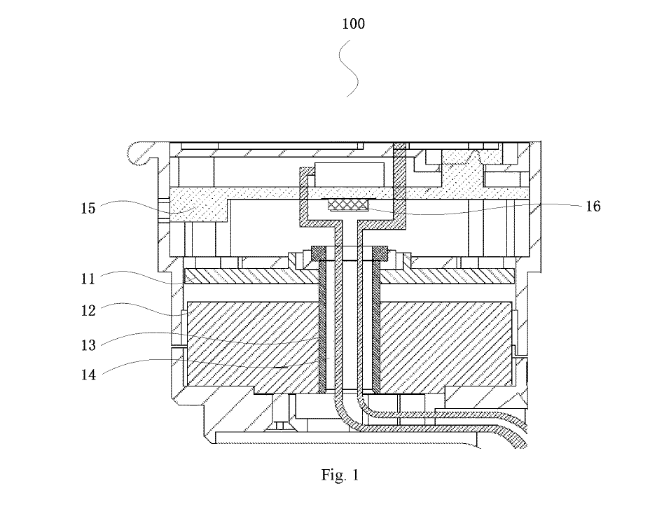

Referring to FIG. 1, a motor 100 provided by a preferred embodiment of the present disclosure includes a stator 11, a rotor 12 and a connection shaft 13. The stator 11 is fixed onto a casing of the motor 100. The rotor 12 is fixedly connected with the connection shaft 13, the connection shaft 13 is rotatably connected with the stator 11 through a bearing (not shown), and the rotor 12 drives the connection shaft 13 to rotate on the stator 11. The connection shaft 13 is provided in an axial direction thereof with a central through hole 14. Preferably, the motor 100 further includes a drive board 15, the drive board 15 is electrically connected with the stator 11 of the motor 100 for driving the motor 100 to rotate. In the present embodiment, the drive board 15 is exemplarily fixed to the back of the motor 100. In addition, the motor 100 further includes a magnetic encoder 16 electrically connected with the drive board 15. FIG. 1 shows an exemplary arrangement that the magnetic encoder 16 is integrated into the drive board 15. In other implementations, the drive board 15 and the magnetic encoder 16 may also be arranged separately, with the magnetic encoder 16 connected with the drive board 15 through a signal wire. The magnetic encoder 16 is arranged to be coaxial with the connection shaft 13, for measuring angle and/or position information of the motor 100 and feeding back the measured information to the drive board 15. In this way, it is possible to adjust the rotation of the motor 100 based on the fed-back angle and/or position information of the motor 100.

If there is a need to connect the motor 100 to an external device through a signal wire, the signal wire may be arranged within the central through hole 14 of the connection shaft 13. Such an arrangement makes it possible to prevent the signal wire from being wound and exposed outside the motor 100, and also prevent the signal wire from being rotated and rewound with the rotation of the motor 100. Therefore, it is also unnecessary to set a segment of the signal wire aside for cooperating with the rotation of the motor 100, thereby effectively saving the material of the signal wire.

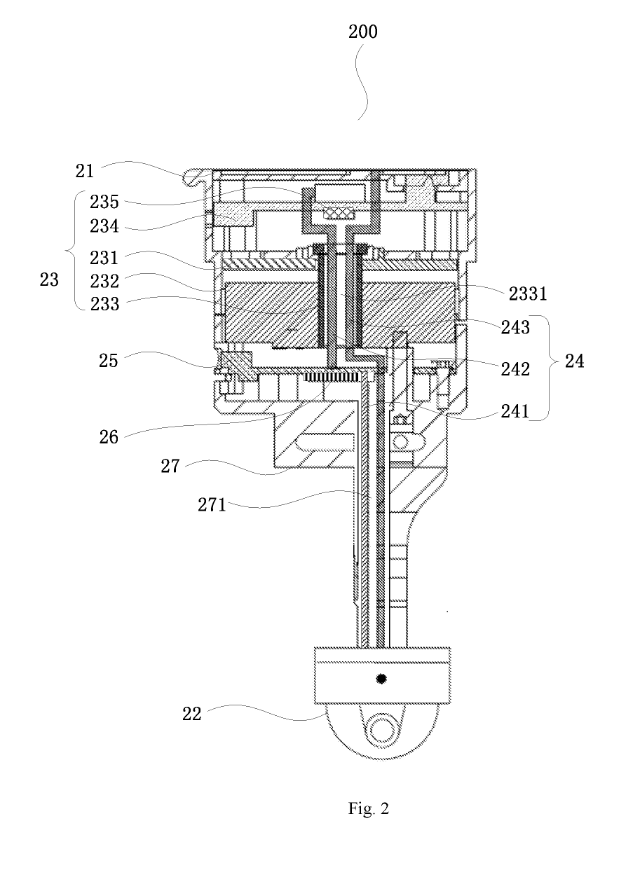

Referring to FIG. 2, an embodiment of the present disclosure further provides a gimbal 200 using the motor described above. The gimbal 200 includes a fixing base 21, a photographing apparatus 22, a motor 23 and a signal wire 24. Here, the motor 23 includes a stator 231, a rotor 232 and a connection shaft 233. The connection shaft 233 is provided with a central through hole 2331. Preferably, the motor 23 further includes a drive board 234 and a magnetic encoder 235. The structure of the motor 23 is similar to that of the motor 100 described above, which will not be described in detail herein.

The fixing base 21 is configured for fixation with a frame (not shown) of an unmanned aerial vehicle, the stator 231 is fixed onto the fixing base 21, and the rotor 232 is fixedly connected with the photographing apparatus 22. FIG. 2 shows an exemplary arrangement that the rotor 232 is fixedly connected with the photographing apparatus 22 by a connector 27. Specifically, the rotor 232 is fixedly connected with one end of the connector 27, and the photographing apparatus 22 is connected with the other end of the connector 27 opposed to the fixing base 21. The rotor 232 drives the connector 27 to rotate, thereby driving the photographing apparatus 22 to rotate. The connector 27 is provided therein with a central through hole 271. The signal wire 24 passes through the central through hole 2331 of the connection shaft 233 and the central through hole 271 of the connector 27. In other embodiments, the connector 27 may also be a fastener such as a bolt, and in this case, the signal wire 24 passes through only the central through hole 2331 of the connection shaft 233.

Preferably, the gimbal 200 further includes a main control board 25 fixed onto the motor 23, and the signal wire 24 includes a first signal wire 241 connected between the control board 25 and the photographing apparatus 22, a second signal wire 242 connected between the control board 25 and the drive board 234, and a third signal wire 243 connected between the photographing apparatus 22 and an image transmission module in the unmanned aerial vehicle. The first signal wire 241 is arranged to pass through the central through hole 271 of the connector 27, for controlling a photographing mode or the like of the photographing apparatus 22. The second signal wire 242 is arranged to pass through the central through hole 2331 of the connection shaft 233, for supplying a drive control signal to the motor 23. The third signal wire 243 is a high-definition signal wire and is arranged to pass through the central through hole 271 of the connector 27 and the central through hole 2331 of the connection shaft 233, for transmitting aerial photographing data acquired by the photographing apparatus 22 to the image transmission module.

The magnetic encoder 235 of the motor 23 measures angle and/or position information of the motor 23, and feeds back the measured information to the drive board 234. The drive board 234 sends the obtained angle and/or position information of the motor 23 to the main control board 25. The main control board 25 may then send a drive control command for another time to the drive board 234 based on the fed-back angle and/or position information of the motor 23, so as to drive and control the rotation of the motor 23.

The gimbal 200 further includes an inertial measurement unit 26. FIG. 2 shows an exemplary arrangement that the inertial measurement unit 26 is integrated into the main control board 25, but in other implementations, the main control board 25 and the inertial measurement unit 26 may be arranged separately, as long as the inertial measurement unit 26 is electrically connected with the main control board 25. The inertial measurement unit 26 is configured to sense attitude information of the photographing apparatus 22 and send the attitude information of the photographing apparatus 22 to the main control board 25. The main control board 25 adjusts the rotation of the motor 23 based on the attitude information of the photographing apparatus 22.

It should be noted that the main control board 25 described above may also be replaced with a control apparatus in the unmanned aerial vehicle, that is, the control apparatus in the unmanned aerial vehicle may be used to control the rotation of the motor 23, the photographing mode of the photographing apparatus 22, and the like. The connection mode in this case may be in such a way that the photographing apparatus 22, the inertial measurement unit 26 and the drive board 234 of the motor 23 are connected directly to the control apparatus in the unmanned aerial vehicle through the signal wire 24. In addition, the motor 23 may also not be provided with the drive board 234, and the stator 231 of the motor 23 may be electrically connected with the control apparatus in the unmanned aerial vehicle, so that the rotation of the motor 23 may be controlled directly by the control apparatus in the unmanned aerial vehicle. It will be appreciated that, in practical applications, the number of the motors 23 in the gimbal 200 may be specifically set according to the application occasions; and although one motor 23 is exemplarily arranged in FIG. 2, it does not limit the present disclosure.

In other embodiments, in the case that the number of the motors 23 included in the gimbal 200 is more than one, two adjacent motors 23 are connected by a connecting arm. Moreover, a guide channel is provided inside the connecting arm, and the signal wire 24 is arranged to pass through the guide channel and the central through hole 2331 of the connection shaft 233 of the motor 23. Here, in the multiple motors 23, first one is fixedly connected with the fixing base 21, and last one is fixedly connected with the photographing apparatus 22. A detailed introduction will be given below by taking a case that the gimbal 200 includes three motors 23 as an example.

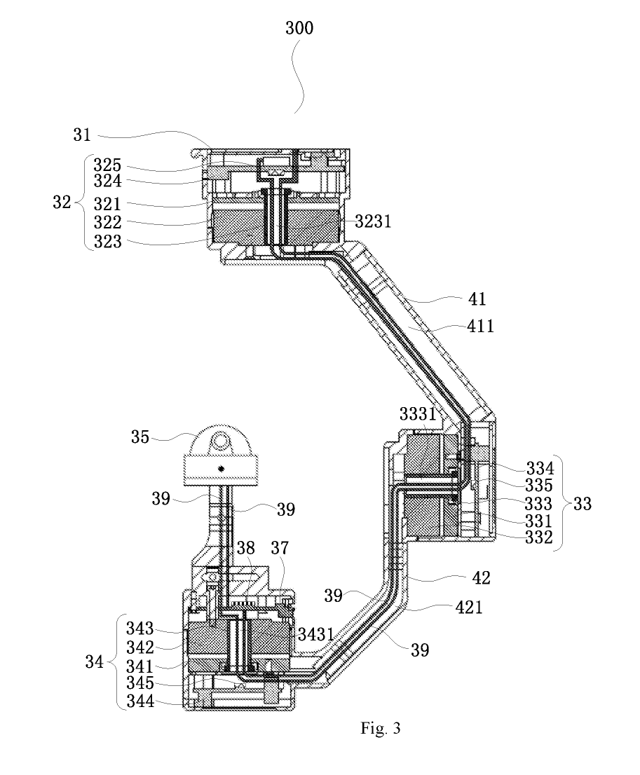

Referring to FIG. 3, a gimbal 300 includes a first motor 32, a second motor 33 and a third motor 34. The first motor 32 is connected with the second motor 33 through a first connecting arm 41, and the second motor 33 is connected with the third motor 34 through a second connecting arm 42. A photographing apparatus 35 is connected onto the third motor 34. The first motor 32 is connected with a lower side of the fixing base 31 by, for example, a fastening means or the like. An upper side of the fixing base 31 is fixed with the frame of the unmanned aerial vehicle. The first motor 32 drives the first connecting arm 41 to rotate, the second motor 33 drives the second connecting arm 42 to rotate, and the third motor 34 drives the photographing apparatus 35 to rotate. A first guide channel 411 is provided inside the first connecting arm 41, and a second guide channel 421 is provided inside the second connecting arm 42. Here, the first motor 32 is the first motor, and the third motor 34 is the last motor. The first motor 32 includes a first stator 321, a first rotor 322, a first connection shaft 323, a first drive board 324 and a first magnetic encoder 325, and the first connection shaft 323 is provided with a first central through hole 3231. Each of the second motor 33 and the third motor 34 has a substantially same structure as that of the first motor 32. Referring to FIG. 3, the second motor 33 includes a second stator 331, a second rotor 332, a second connection shaft 333, a second drive board 334 and a second magnetic encoder 335, and the second connection shaft 333 is provided with a second central through hole 3331. The third motor 34 includes a third stator 341, a third rotor 342, a third connection shaft 343, a third drive board 344 and a third magnetic encoder 345, and the third connection shaft 343 is provided with a third central through hole 3431.

An embodiment of the present disclosure further provides a gimbal based on the motor as described above, which includes a fixing base, a photographing apparatus, a signal wire and at least one motor as described above. The fixing base is connected with the photographing apparatus through the at least one motor. The signal wire is arranged to pass through the central through hole of the connection shaft of the at least one motor.

An embodiment of the present disclosure further provides a gimbal based on the motor as described above, which includes a fixing base, a photographing apparatus, a signal wire and at least one motor as described above. The fixing base is connected with the photographing apparatus through the at least one motor. The signal wire is arranged to pass through the central through hole of the connection shaft of the at least one motor.

An embodiment of the present disclosure further provides a gimbal based on the motor as described above, which includes a fixing base, a photographing apparatus, a signal wire and at least one motor as described above. The fixing base is connected with the photographing apparatus through the at least one motor. The signal wire is arranged to pass through the central through hole of the connection shaft of the at least one motor.

A main control board 37 is fixed onto the third motor 34, and is connected with the first drive board 324, the second drive board 334 and the third drive board 344 through the signal wire 39, respectively. An inertial measurement unit 38 is fixed onto the third motor 34, and is connected with the main control board 37 through the signal wire 39. The inertial measurement unit 38 is integrated onto the main control board 37 for sensing attitude information of the photographing apparatus 35 and sending the attitude information of the photographing apparatus 35 to the main control board 37. The photographing apparatus 35 is connected with an image transmission module of the unmanned aerial vehicle through the signal wire 39, to transmit the aerial photographing data acquired by the photographing apparatus 35 to the image transmission module of the unmanned aerial vehicle. The signal wire 39 is arranged to pass through the first guide channel 411, the second guide channel 421, the first central through hole 3231 of the first connection shaft 323 of the first motor 32, the second central through hole 3331 of the second connection shaft 333 of the second motor 33, and the third central through hole 3431 of the third connection shaft 343 of the third motor 34.

On the basis of the embodiment described above, the first connection shaft 323 of the first motor 32 is set as a yaw axis, the second connection shaft 333 of the second motor 33 is set as a rolling axis, and the third connection shaft 343 of the third motor 34 is set as a pitching axis. In this implementation, the first motor 32 rotates around the yaw axis in a range of +340° to −340°, the second motor 33 rotates around the rolling axis in a range of +40° to −220°, and the third motor 34 rotates around the pitching axis in a range of +45° to −135°. The yaw, rolling and pitching axes are three axes perpendicular to one another. The embodiment of the present disclosure may enable the photographing apparatus 35 to be adjusted on the photographing angle and/or position in three degrees of freedom. It should be noted that, in other implementations, it may also be arranged that the first motor 32 rotates around the yaw axis in a range of +360° to −360°, the second motor 33 rotates around the rolling axis in a range of +360° to −360°, and the third motor 34 rotates around the pitching axis in a range of +360° to −360°, where the embodiments of the present disclosure are not limited to the ranges of rotation described above.

In the present disclosure, it is possible to prevent the signal wire 39 from being exposed outside the gimbal 300, by arranging the signal wire 39 to pass through the first central through hole 3231 of the first connection shaft 323 of the first motor 32, the second central through hole 3331 of the second connection shaft 333 of the second motor 33, the third central through hole 3431 of the third connection shaft 343 of the third motor 34, the first guide channel 411 of the first connecting arm 41, and the second guide channel 421 of the second connecting arm 42. In addition, since the signal wire 39 is arranged in each of the guide channels (the first guide channel 411 and the second guide channel 421) and each of the central through holes (the first central through hole 3231, the second central through hole 3331 and the third central through hole 3431), the signal line 39 would not be wound with the rotations of the motors, and there is no need to set a segment of the signal wire 39 aside for cooperating with the rotations of the motors, thereby effectively saving the material of the signal wire 39.

In FIG. 3, the main control board 37 is exemplarily arranged on the third motor 34, which does not limit the present disclosure. In other implementations, the main control board 37 may be arranged on any one of the motors of the gimbal 300, for example, it may be arranged on the first motor 32. Here, the photographing apparatus 35 may be a camera, a video camera or the like.

It should be noted that, in the case that the motor of the gimbal 300 does not include a drive board, the main control board 37 may be electrically connected with the stator of the motor through the signal wire 39. In addition, all the motors in the gimbal 300 provided by the embodiment of the present disclosure may share one drive board, in this case, the drive board may be fixedly connected onto any one of the motors in the gimbal 300. In other words, only one motor in the gimbal 300 is provided with a drive board which drives all the motors in the gimbal 300 to rotate.

It should be noted that the signal wire 39 described above includes a high-definition data signal wire, a control signal wire and a feedback signal wire. The high-definition data signal wire transmits the aerial photographing data acquired by the photographing apparatus 35. The control signal wire is configured to transmit a drive control signal for each motor, a photographing mode control signal for the photographing apparatus 35 and the like. The feedback signal wire is configured to transmit the attitude information of the photographing apparatus 35, the angle and/or position information of each motor and the like.

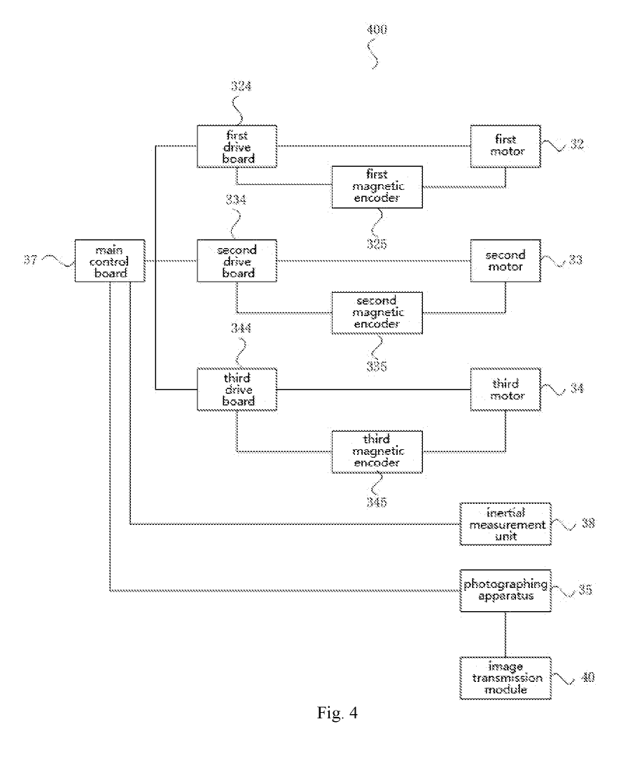

Referring to FIG. 4, a control system 400 includes an image transmission module 40, a first motor 32, a second motor 33, a third motor 34, a main control board 37 and a photographing apparatus 35. Here, through a high-definition data signal wire, the photographing apparatus 35 is connected with the image transmission module 40 of the unmanned aerial vehicle, and electrically connected with the main control board 37. The first drive board 324, the second drive board 334 and the third drive board 344 each are connected with the main control board 37 through a feedback signal wire. The inertial measurement unit 38 is connected with the main control board 37 through a feedback signal wire. When the photographing apparatus 35 is moved, the inertial measurement unit 38 senses the attitude of the photographing apparatus 35 and transmits it to the main control board 37 through the feedback signal wire. The main control board 37 generates control commands based on the received attitude information of the photographing apparatus 35, and sends the control commands to the first drive board 324, the second drive board 334 and the third drive board 344 through control signal wires, respectively. The first drive board 324, the second drive board 334 and the third drive board 344 drive, based on their corresponding control commands, their respective motors (the first motor 32, the second motor 33 and the third motor 34) to rotate, respectively. In addition, the first magnetic encoder 325, the second magnetic encoder 335 and the third magnetic encoder 345 measure the angle and/or position information of their respective motors, and then send the measured information to the main control board 37 via the first drive board 324, the second drive board 334 and the three drive board 344 through the feedback signal wires, respectively. The main control board 37 sends control commands for another time to the first drive board 324, the second drive board 334 and the third drive board 344, based on the received angle and/or position information of the individual motors, so as to adjust the rotations of the individual motors, thereby finally achieving precise control of the angle and position of the photographing apparatus 35 in the photographing operation.

As described above, in the embodiments of the present disclosure, the connection shaft of the motor is provided with a central through hole, which enables the signal wire to be arranged to directly pass through the inside of the motor, thereby effectively preventing the signal wire from being wound outside the motor. Meanwhile, by arranging the signal wire (including the high-definition data signal wire, the control signal wire and the feedback signal wire) to pass through the individual motors and guide channels, the wire is shortened, effectively saving the material of the signal wire. In addition, since the longer the length of the high-definition data signal wire connected between the photographing apparatus and the unmanned aerial vehicle, the greater the attenuation of the image transmission signal, the shortened wire also improves the effect of images transmitted though the high-definition data signal wire.

It is to be noted that the foregoing is merely illustrative of preferred embodiments of the present disclosure and the technical principle applied thereto. It will be understood by those skilled in the art that the present disclosure is not limited to the particular embodiments described herein. And it would be apparent to those skilled in the art that various obvious modifications, rearrangements and substitutions can be made without departing from the scope of protection of the present disclosure. Thus, although the present disclosure has been described in detail with reference to the above embodiments, the present disclosure is not limited to the above embodiments, and may also encompass other further equivalent embodiments without departing from the concept of the present disclosure. The scope of the present disclosure is to be determined by the scope of the appended claims.

1. A motor, comprising a stator and a rotor, wherein the motor further comprises a connection shaft, the rotor is fixedly connected with the connection shaft, the connection shaft is rotatably connected with the stator through a bearing, and the connection shaft is provided in an axial direction thereof with a central through hole.

2. The motor according to claim 1, wherein the motor further comprises a drive board, with the drive board electrically connected with the stator of the motor and driving the motor.

3. The motor according to claim 2, wherein the motor further comprises a magnetic encoder, with the magnetic encoder electrically connected with the drive board and configured to measure angle and/or position information of the motor and feed back the measured information to the drive board.

4. A gimbal, comprising a fixing base, a photographing apparatus, a signal wire and at least one motor, wherein:
the at least one motor each comprises a stator, a rotor and a connection shaft, the rotor is fixedly connected with the connection shaft, the connection shaft is rotatably connected with the stator through a bearing, and the connection shaft is provided in an axial direction thereof with a central through hole;
the fixing base is connected with the photographing apparatus through the at least one motor; and
the signal wire is arranged to pass through the central through hole of the connection shaft of the at least one motor.

5. The gimbal according to claim 4, wherein the motors comprised in the gimbal are in number of two or three, with the two or three motors connected in series, and the gimbal further comprises a connecting arm connected between two adjacent ones of the motors;
wherein a guide channel is provided inside the connecting arm, and the signal wire is arranged to pass through the guide channel and the central through holes of the connection shafts of the motors; and
in the motors connected in series, a first one is fixedly connected with the fixing base, and a last one is fixedly connected with the photographing apparatus.

6. The gimbal according to claim 5, wherein the axial directions of the connection shafts of the two or three motors are perpendicular to one another.

7. The gimbal according to claim 4, wherein the gimbal further comprises a main control board, with the main control board fixed onto any of the motors of the gimbal and configured to adjust rotation of the at least one motor based on attitude information of the photographing apparatus.

8. The gimbal according to claim 7, wherein:
the main control board is electrically connected with the stator of the at least one motor through the signal wire; or
the at least one motor each comprises a drive board, and the main control board is electrically connected with the drive board of the motor through the signal wire.

9. The gimbal according to claim 4, wherein the at least one motor in the gimbal uses one drive board, and the drive board is fixedly connected onto any of the motors of the gimbal.

10. The gimbal according to claim 4, wherein the gimbal further comprises an inertial measurement unit and a main control board, the inertial measurement unit is electrically connected with the main control board and fixed onto the motor connected with the photographing apparatus, and the inertial measurement unit is configured to sense attitude information of the photographing apparatus and send the attitude information of the photographing apparatus to the main control board.

11. The gimbal according to claim 4, wherein the motor further comprises a drive board, with the drive board electrically connected with the stator of the motor and driving the motor.

12. The gimbal according to claim 11, wherein the motor further comprises a magnetic encoder, with the magnetic encoder electrically connected with the drive board and configured to measure angle and/or position information of the motor and feed back the measured information to the drive board.

13. A gimbal, comprising at least one motor comprising a stator, a rotor and a connection shaft, wherein the rotor is fixedly connected with the connection shaft, the connection shaft is rotatably connected with the stator through a bearing, and the connection shaft is provided in an axial direction thereof with a central through hole.

14. The gimbal according to claim 13, wherein the motor further comprises a drive board, with the drive board electrically connected with the stator of the motor and driving the motor.

15. The gimbal according to claim 14, wherein the motor further comprises a magnetic encoder, with the magnetic encoder electrically connected with the drive board and configured to measure angle and/or position information of the motor and feed back the measured information to the drive board.

16. The gimbal according to claim 13, wherein the at least one motor in the gimbal uses one drive board, and the drive board is fixedly connected onto any of the motors in the gimbal.
